(19) United States
(12) Patent Application Publication
(10) Pub. No.: US 2004/0116002 A1
(43) Pub. Date: Jun. 17, 2004

(54) Female contact having a cage structure comprising a blade-holder module

(76) Inventors: Dominique Rozet, Rambouillet (FR); Richard Kakkuri, Rochester Hill, MI (US); Gerard Mulot, Nogent le Roi (FR); Frederic Regnier, Raizeux (FR); Glen Sparks, Woodhaven, MI (US)

Correspondence Address: PERMAN & GREEN, 425 POST ROAD, FAIRFIELD, CT, 06824, US

(21) Appl. No.: 10/433,800

(22) PCT Filed: Dec. 6, 2001
(86) PCT No.: PCT/FR01/03857

(30) Foreign Application Priority Data
Dec. 7, 2000 (FR) 00/15920
Dec. 7, 2000 (FR) 00/15924
Dec. 7, 2000 (FR) 00/15923

(51) Int. Cl. H01R 13/187

(52) U.S. Cl. 439/843

(57) ABSTRACT

The invention concerns a female contact having a parallelpiped cage structure comprising a blade-holder module (36) designed to receive a plug. The invention aims at producing on an industrial scale a contact with dependability of electrical connection and adapted to receive plugs of different widths.

The present invention concerns a female contact having a cage structure with a blade-holder module, notably with frames or a support spring.

A female contact with a cage structure is known more particularly from U.S. Pat. No. 5,613,885. Such a contact is designed to receive a male plug that inserts through the front face of said cage. In the back, this cage has deformable tabs designed to be crimped onto an electrical conductor to which it must be coupled.

The difficulty of creating such contacts is in obtaining a secure electrical contact. Moreover, this electrical contact between the plug and this cage must be of [high] quality.

In fact, these contacts are small in size and are subjected to difficult environments, notably in automobile connections. They are subjected to vibrations, large temperature variations and must imperatively be absolutely reliable.

A solution is known that consists of arranging flexible blades in a cage that serves as a rigid structure, assuring the interface and electrical contact.

In the above-mentioned patent, a blade is provided that is bent in a C-shape on itself, in the length direction, which is extended into the body of the cage along its entire length. This blade has a deformation of each of its arms, in order to induce a contraction and give a spring effect to said blades.

The present invention pertains to a female contact that assures an effective and reliable electrical contact, in which the plug that it receives can be removed and reinserted without damage and whose manufacture is industrially possible.

Moreover, even after removal of the plug, relaxation of stresses cannot bring about disengagement of the module.

Another problem posed by this type of contact is “fretting corrosion”. This phenomena is generated by vibrations and friction between the plug and the cage contact. Metal particles are abraded, then oxidize and reduce the electrical conduction between the metal parts. Once this phenomenon begins, it rapidly becomes more marked.

More particularly, the present invention responds to additional stresses due to the fact that such contacts must be miniaturized. In order to give an order of magnitude in this case, a wall thickness for the contact cage of the order of 0.2 mm, a blade thickness of the order of 0.1 mm and dimensions for the plug received in this female contact of the order of 0.6×1.2 mm can be cited.

This contact also has the advantage of being multipurpose in order to receive different widths of plugs, and bears polarization means.

The present invention will now be described with reference to the attached drawings which represent a preferred embodiment and variants, the different figures of these drawings corresponding to:

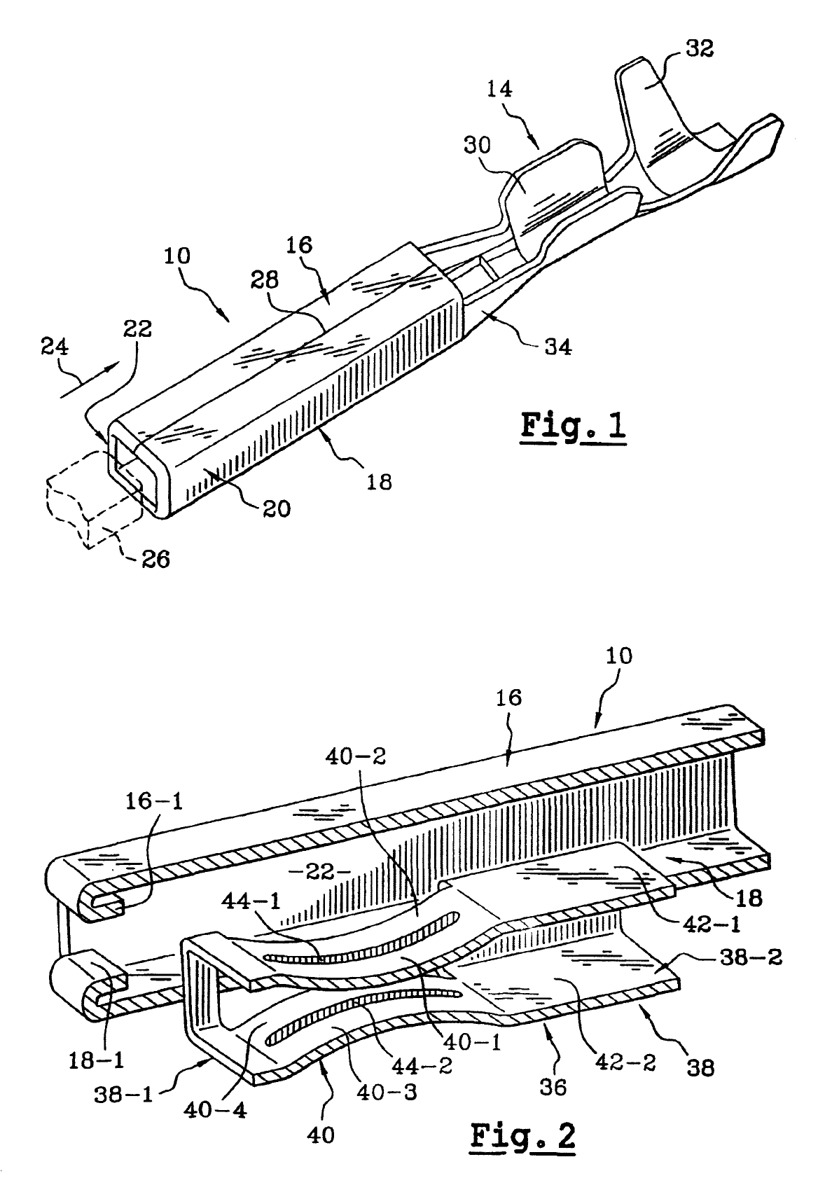

FIG. 1, a perspective view of a female cage contact,

FIG. 2, an exploded perspective view of the cage in partial section and the complete blade-holder module,

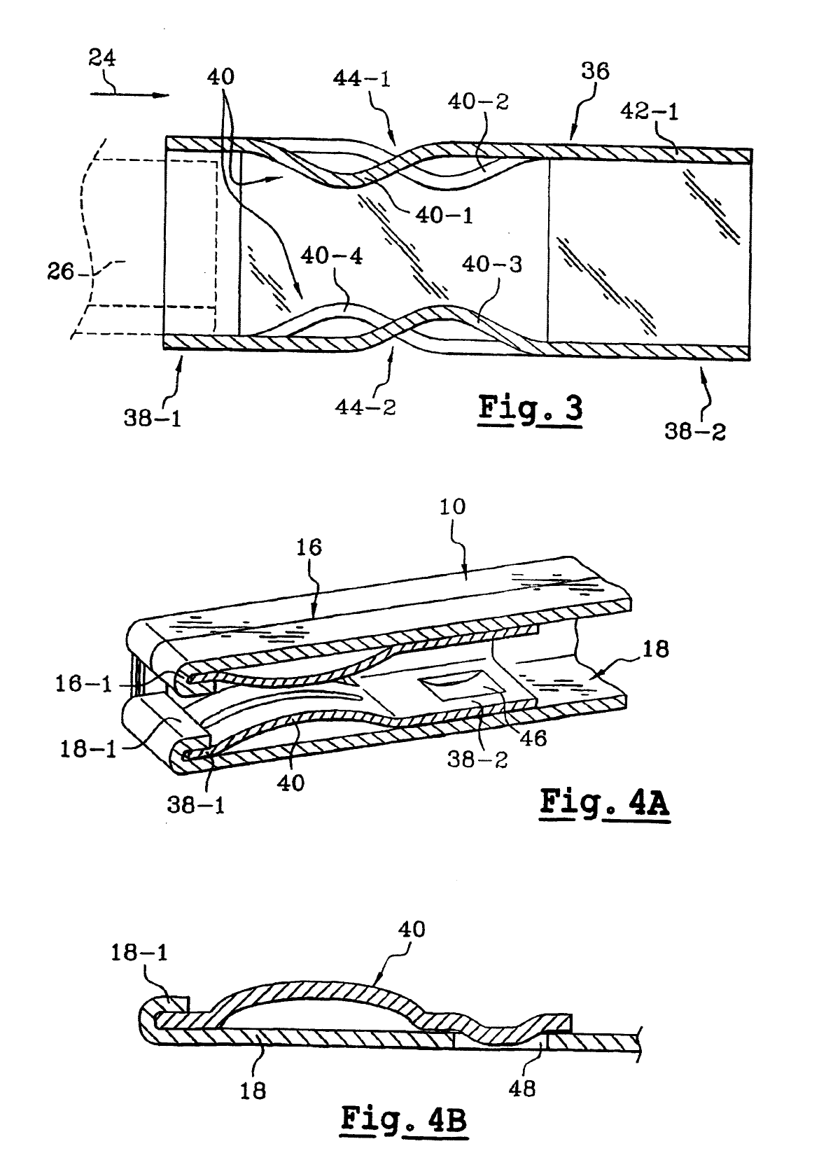

FIG. 3, an elevational lateral view of the blade-holder module,

FIG. 4A, a perspective view in partial section of one way of mounting the blade-holder module in a cage,

FIG. 4B, a longitudinal sectional view of a cage part and the blade-holder module after mounting, and

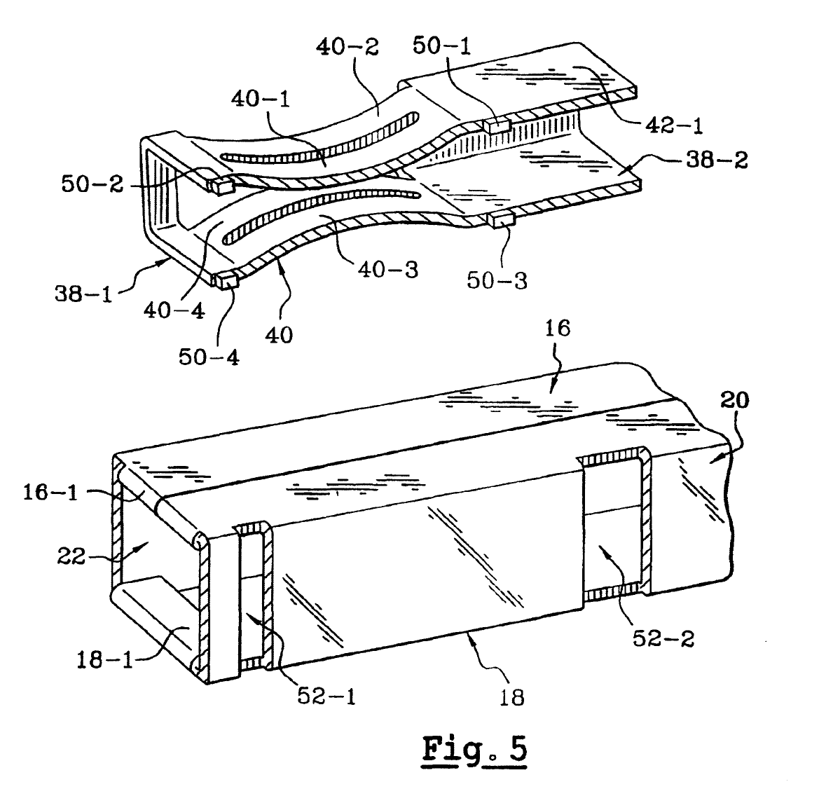

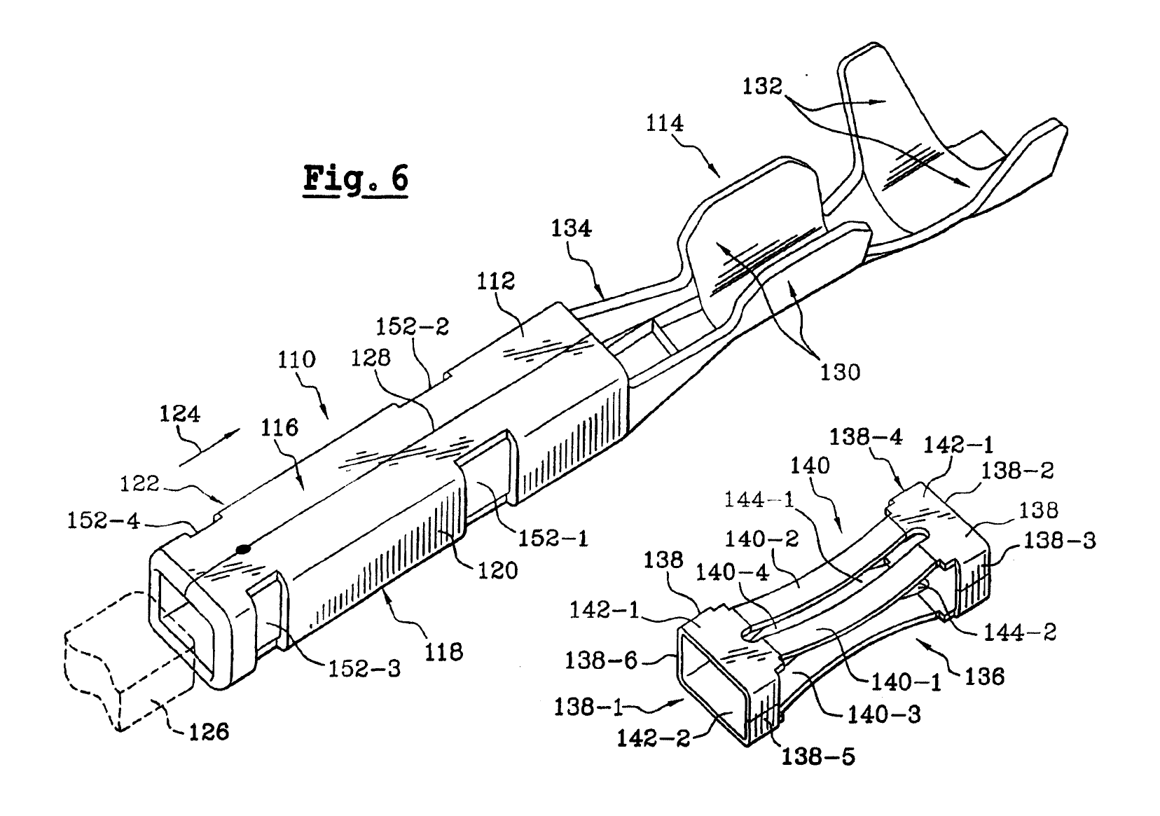

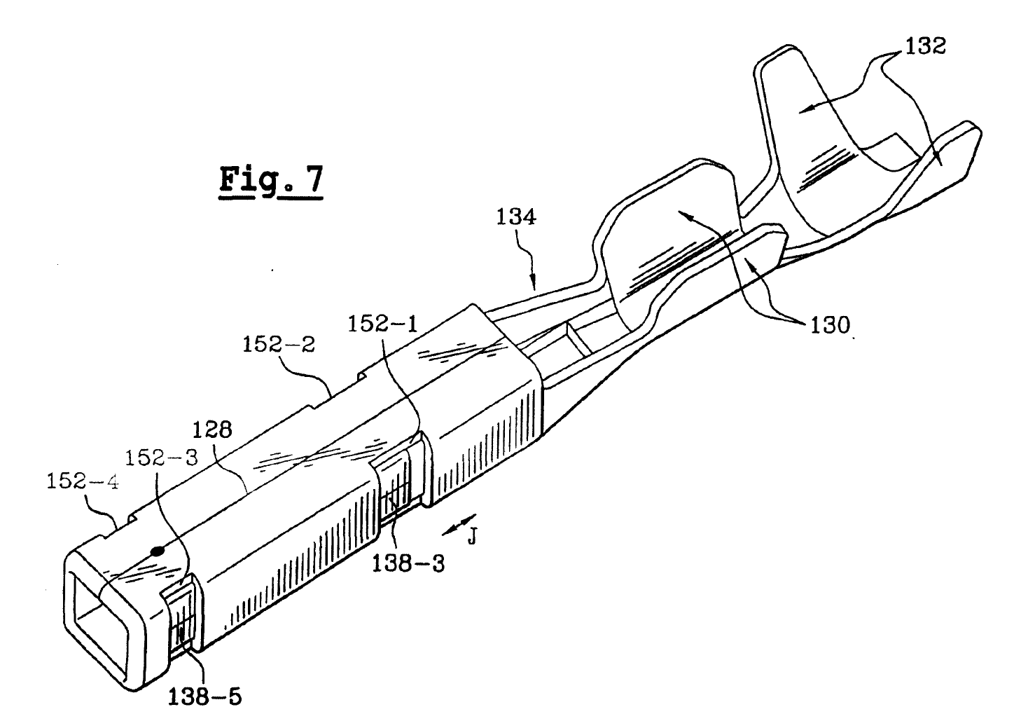

FIG. 5, an exploded perspective view of one variant of embodiment for mounting the blade-holder module.

FIG. 6, an exploded perspective view of the female cage contact and of a variant of the blade-holder module called the frame type,

FIG. 7, a lateral elevational view of the cage with its blade-holder module of the frame type of FIG. 7, after insertion, and

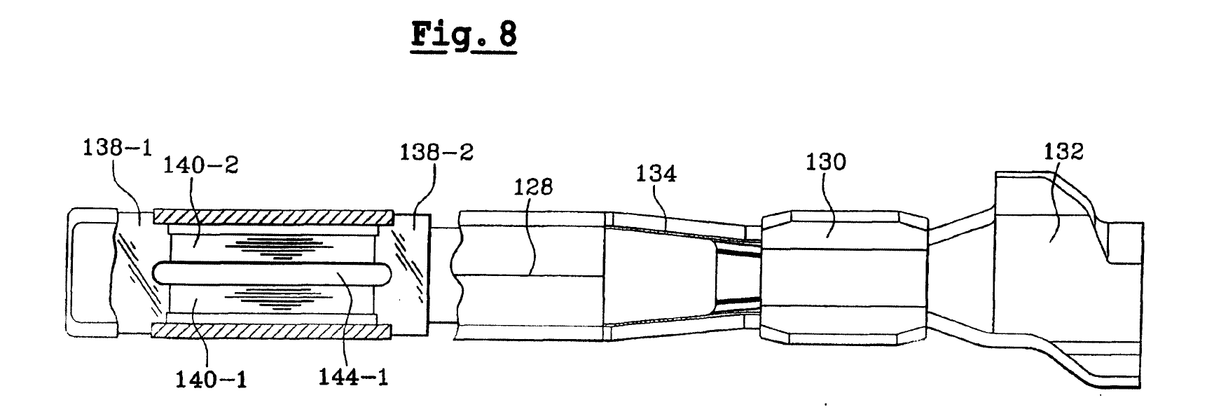

FIG. 8, a top view, partially cut-away, of the contact of FIG. 6 with the frame-type blade-holder module inserted in its cage,

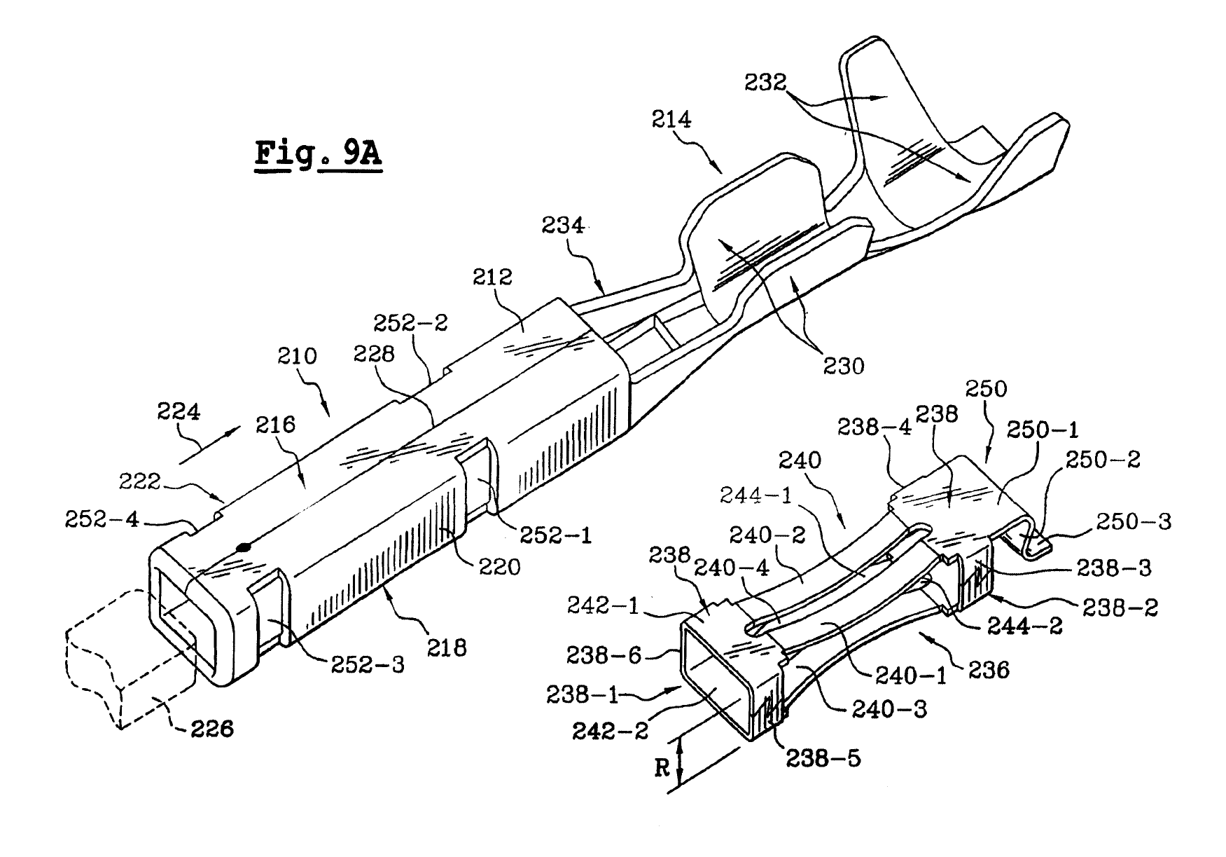

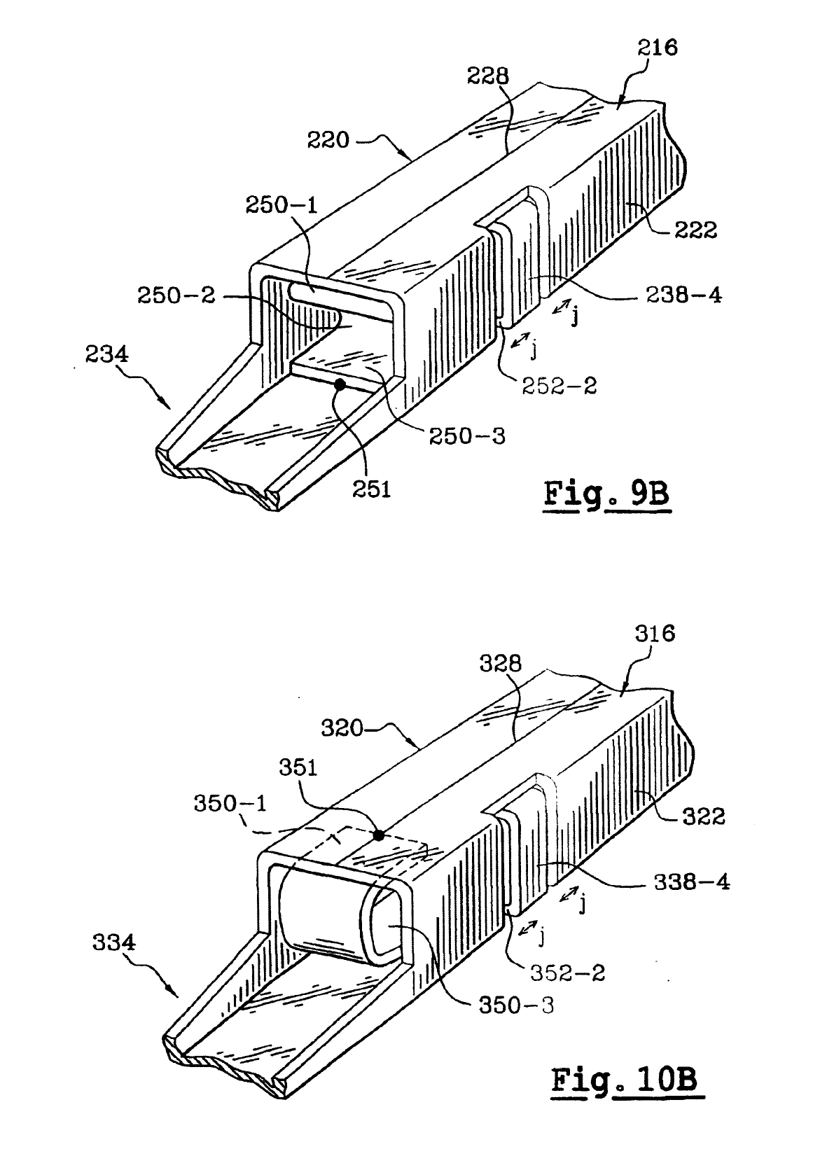

FIG. 9A, an exploded perspective view of the female cage contact and the blade-holder module with Z-shaped support spring,

FIG. 9B, a partial perspective view from the rear of the cage with its blade-holder module with Z-shaped support spring after insertion.

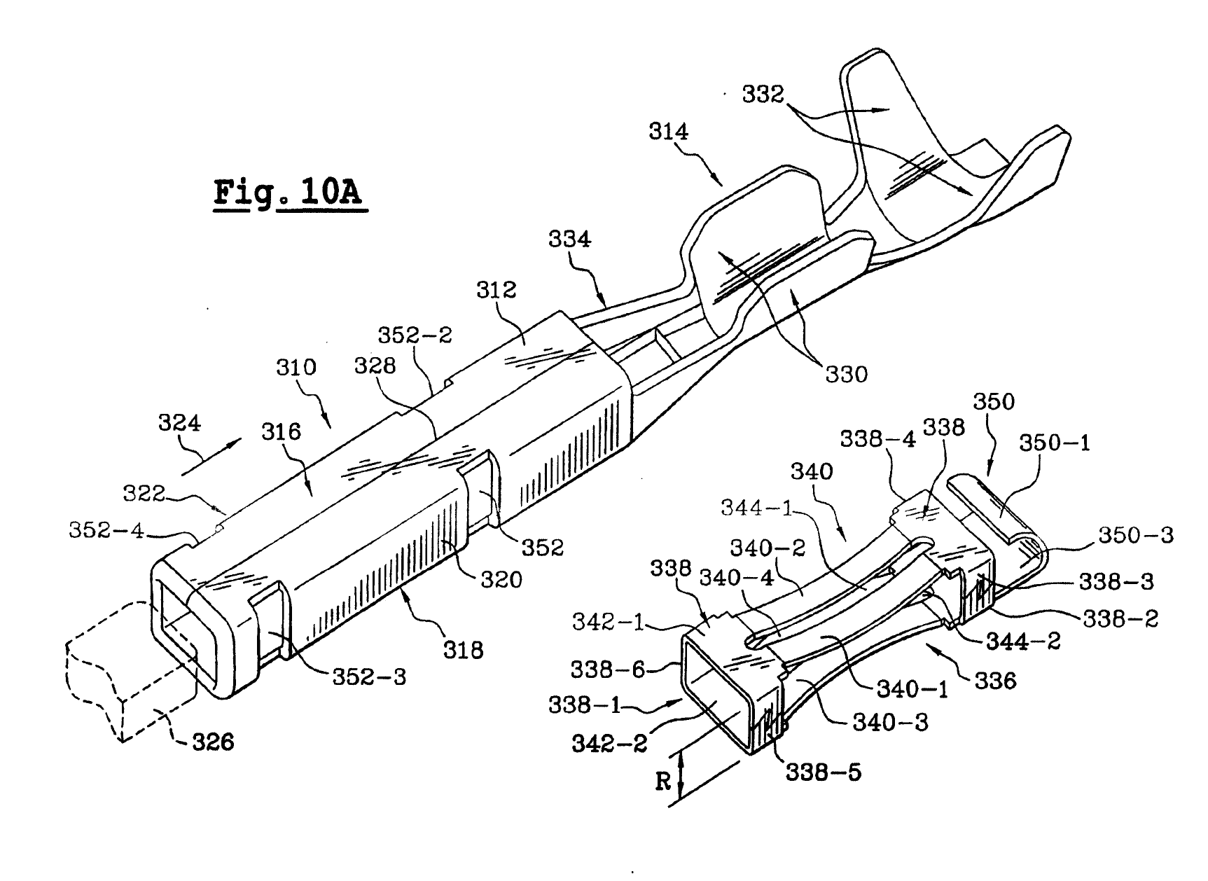

FIG. 10A, a variant of embodiment that corresponds to an optimized mode of the embodiment of FIG. 9A, but with a C-shaped support spring,

FIG. 10B, a partial perspective view from the rear of the cage with its blade-holder module with C-shaped support spring after insertion.

In FIG. 1, a female cage contact 10 is shown.

This contact comprises cage 12 properly speaking, of parallelepiped shape, and means 14 for joining with an electric cable, not shown.

The cage is obtained, in the present case, by bending a blank and comprises an upper face 16, a lower face 18 opposite it, a right lateral face 20 and a left lateral face 22 looking along direction 24 for introduction of a plug 26, shown by the dashed line. Line 28 for joining the blank after bending is borne by upper face 16.

In a known manner, joining means 14 comprise wing-like projections 30 for crimping onto the metal part of the cable and wing-like projections 32 for crimping onto the sheath of this cable.

A transition zone 34 assures the continuity between the cage and these coupling means 14.

In the embodiment according to the present invention, the cage can additionally comprise flaps 16-1, 18-1, 20-1 and 22-1, arising from an extension of each of the faces.

In the preferred embodiment of the invention shown particularly in FIG. 2, only flaps 16-1 and 18-1 are present.

In this same FIG. 2, a blade-holder module 36 is shown.

This module comprises a rigid body 38 and blades 40.

In this embodiment, rigid body 38 is made up of a profile with a U-shaped cross section with an upstream part 38-1 separate from a downstream part 38-2.

The blades are four in number, two upper blades 40-1, 40-2 and two lower blades 40-3, 40-4 and connect the two separate upstream and downstream parts of body 38. These blades have opposite curvatures so that their summits [top parts] approach each other.

These blades are more particularly manufactured with body 38 and are found in the extension of upper face 42-1 and lower face 42-2. These blades are more or less in the plane of the wing-like projections of the U between the upstream part and the downstream part, of similar curvature. There are two blades which are each divided by a longitudinal median opening 44-1 and 44-2 which generates these pairs of blades.

A perfect symmetry is noted with regard to the longitudinal direction but it is also possible to make a different arrangement in the case of a variant which is shown in FIG. 3. In this figure, only module 36 is shown in detail.

The blades of the same pair each have a top part with a curvature corresponding to the contact point with the plug to be received, offset along the longitudinal axis. Thus upper blades 40-1 and 40-2 have, in the first case, an upstream point of contact and, in the second case, a downstream point of contact. The same is true for the lower blades, so that the four points permit assuring an elastic contact of good quality of one part and especially are supported on the plug in a secure and also perfectly equilibrated manner, which contributes to the electrical quality of the contact.

The blades of the same face can also each have an upstream point of contact while the blades of the other opposite face have a downstream point of contact. This embodiment is a simple baffle.

In the arrangement indicated above, it is noted that the two faces, upper face 42-1 and lower face 42-2 of the module come to be positioned parallelly to upper face 16 and lower face 18 of cage 10, the base of the U ending up parallel to one of the lateral faces.

More particularly, the two upper and lower faces are immobilized mechanically under flaps 16-1 and 18-1 of the cage, as is shown in detail in FIG. 4B.

This arrangement under the flaps also permits having available an additional point of contact for the plug and assures guidance upon introduction.

In order to hold the module in position in the cage, in addition to or instead of immobilization under the flaps, associated means are provided, such as a depression 46, in accordance with the embodiment shown in FIG. 4A.

This depression, produced for example by stamping, is designed to cooperate with an opening 48 created in the body of the cage, more particularly in lower face 18.

Nevertheless, this opening has a longitudinal dimension which exceeds the necessary length to receive this depression and generates a play J. This play permits the blades to be deformed and extended when the introduced plug imposes a reduction of the curvature. Simultaneously, this induces the corresponding extension of the module.

The depression can also be created in the cage and the opening can be created in the face of the module without changing the result.

Another variant, for which a perspective view is shown in FIG. 5, proposes novel means for mounting the module in the cage body.

Identical elements bear the same references.

Each of faces 42-1 and 42-2 bear a pair of studs 50-1 to 50-4, positioned on upstream part 38-1 and downstream part 38-2, on either side of blades 40.

These studs project along a length roughly equal to the thickness of the wall of the cage and are situated in the plane of the faces that bear them.

In a homothetic manner, body 12 of the cage comprises, on the corresponding face, in this case right lateral face 20, two openings 52-1 and 52-2, above and below, which are provided to receive studs 50-1 to 50-4.

In an analogous manner and for the same reasons, rear opening 52-2 has a longer length than the corresponding dimension of the studs that it receives to generate the necessary play J for the extension of the blades and the module when the plug to be received is introduced.

A different and more limited arrangement consists of only providing one pair of studs, one borne by the upper face and the other borne by the lower face, provided so as to cooperate with a single opening.

In order to prevent any risk of erroneous introduction, it is possible to adjoin polarization means in a known manner for the contact cage thus described. Such means are present in the form of an asymmetry of the cage which is provided, for example with a boss, while the reception socket, not shown, has a conjugate profile.

Such arrangements permit increasing the capacity for such a female contact to receive a contact blade of variable width, since on one of the faces, the module has a reduced thickness due to the absence of a wall.

A first variant called a frame-type blade-holder module, is shown in FIGS. 6 to 8. Identical elements bear the same references as those described above, plus 100.

In FIG. 6, a female cage contact 110 is shown.

This contact comprises cage 112 properly speaking, of parallelepiped shape, and means 114 for joining with an electric cable, not shown.

The cage is obtained by bending a blank and comprises an upper face 116, a lower face 118 opposite it, a right lateral face 120 and a left lateral face 122 looking along direction 124 for introduction of a plug 126, shown by the dashed line. Line 128 for joining the blank after bending is borne by upper face 116.

In a known manner, joining means 114 comprise wing-like projections 130 for crimping onto the metal part of the cable and wing-like projections 132 for crimping onto the cable sheath.

A transition zone 134 assures the continuity between the cage and these coupling means.

In this same FIG. 1, a frame-type blade-holder module 136 is shown.

This module comprises a rigid body 138 and blades 140.

In this embodiment, rigid body 138 is made up of a profile with a cross section forming a closed frame with an upstream part 138-1 separated from a downstream part 138-2.

The blades are four in number, two upper blades 140-1, 140-2 and two lower blades 140-3, 140-4 and connect the two separate upstream and downstream parts of body 138. These blades have opposite curvatures so that their top parts approach each other.

These blades are more particularly manufactured with body 138 and are found in the extension of upper face 142-1 and lower face 142-2, with similar curvature. There are two blades which are each divided by a longitudinal median opening 144-1 and 144-2 which generates these pairs of blades.

A perfect symmetry is noted with regard to the longitudinal direction.

In the arrangement indicated above, it is noted that the two faces, upper face 142-1 and lower face 142-2 of the module come to be positioned parallelly to upper face 116 and lower face 118 of cage 110.

This module has the particular feature of creating a frame whose upstream part 138-1 and downstream part 138-2 are identical with lateral faces 138-3 to 138-6 for housing, which project out relative to the general space occupied by of the module. This depth of projection corresponds roughly to the thickness of wall 120 or 122 of the cage.

A perspective [view] of the contact with its module inserted is shown in FIG. 7. FIG. 8, which corresponds to a top view, partially cut-away, permits completing the representation and allows for better understanding of the arrangement.

In a manner homothetic to the placement of faces 138-3 to 138-6 for housing the module, two downstream openings 152-1, 152-2 and two upstream openings 152-3 and 152-4 are arranged in body 112 of the cage on the corresponding faces, which openings are provided to receive the projecting faces of the module.

Downstream openings 152-1 and 152-2 each have a longer length than the dimension of faces 138-3 and 138-4 that they receive to generate play J necessary for the extension of the blades and the module during the introduction of the plug to be received.

In fact, during the introduction of the plug, the curvature of the blades is decreased, which necessarily induces a lengthening of the module.

It is also noted that this arrangement permits holding the module in translation once it is inserted in the cage, since, even in the case of relaxation of the stresses, notably upon removal of the plug previously inserted, for example, the module is held in place in the cage.

One of the advantages of such an arrangement is the freeing-up of useful space throughout almost all of the cage. Since the projecting faces have a thickness roughly identical to that of the walls of the cage, these faces are housed in the thickness of the wall of the cage and free the inner space of the cage allowing the use and the passage of plugs of greater dimensions, for the smallest width.

In the different figures, a cage is shown that has just been folded in order to assure security [a secure connection] when the cage itself relaxes; it may be useful, although not necessary, to make one or more solder points, for example by laser gun, along joining line 128. This contributes to reinforcing the stiffness of the cage.

A cage created according to this embodiment is very rigid and the symmetric module assures a great stability once it is mounted and also facilitates industrial manufacture.

The preferred embodiment that has been described above can be very small in the sense that faces 138-3 to 138-6 can be limited to a single upstream pair 138-5, 138-6 or to a single lateral pair of faces 138-3, 138-5 or 138-4, 138-6.

There is a loss of symmetry and a greater occupation of the inner space of the cage, but for certain applications, such an embodiment can prove sufficient. The number of openings in the cage is reduced still further.

In the embodiment that has just been described, it is also noted that the opening of the cage permitting introduction of the plug need not necessarily have flaps. This cutting out and folding operation is therefore eliminated. Advantageously, during cutting of the blank, a small chamfer can be provided in the thickness so as to facilitate the introduction of the plug to be received once the cage is formed and the module is positioned.

In order to eliminate any risk of erroneous introduction, it is possible to adjoin in a known manner the polarization means for the cage contact thus described. Such means are present in the form of an asymmetry of the cage which is provided, for example with a boss, while the reception socket, not shown, has a conjugate profile.

The cost of such a contact is reduced and the manufacturing steps are simplified industrially.

Two other variants having common points will now be described in detail and the elements identical to the preceding first embodiment will bear the same references increased by 200 and 300, respectively.

In FIG. 9A, a female cage contact 210 is shown which comprises cage 212 properly speaking, of parallelepiped shape, and means 214 for coupling with an electrical cable, not shown.

The cage is still obtained by bending a blank and comprises an upper face 216, a lower face 218 opposite it, a right lateral face 220 and a left lateral face 222 looking along the direction 224 for introduction of a plug 226, shown by the dashed line. Joining line 228 of the blank after bending is borne by upper face 216.

This cage, just after folding, has one or more solder points, for example [produced] by laser gun, along joining line 228 in order to assure security [of connection] with regard to relaxation of the cage itself. This also contributes to reinforcing the stiffness of the cage.

In a known manner, coupling means 214 comprises wing-like projections 230 for crimping onto the metal part of the cable and wing-like projections 232 for crimping onto the sheath of the cable.

A transition zone 234 assures the continuity between the cage and these coupling means.

In this same FIG. 1A, a blade-holder module 236 with support spring is shown.

This module comprises a rigid body 238 and blades 240.

In this embodiment, rigid body 238 is made up of a profile with a cross section forming a closed frame with an upstream part 238-1 separated from a downstream part 38-2.

The blades are four in number, two upper blades 240-1, 240-2 and two lower blades 240-3, 240-4 and connect the two separate upstream and downstream parts of body 238. These blades have opposite curvatures so that their top parts approach each other.

These blades are more particularly manufactured with body 238 and are found in the extension of upper face 242-1 and lower face 242-2, with similar curvature. There are two blades each divided by a longitudinal median opening 244-1 and 244-2 that generate these pairs of blades.

A perfect symmetry is noted with regard to the longitudinal direction.

In the arrangement indicated above, it is noted that the two faces, upper face 242-1 and lower face 242-2 of the module come to be positioned parallelly to upper face 216 and lower face 218 of cage 210.

This module has a frame whose upstream part 238-1 and downstream part 238-2 are identical with lateral faces 238-3 to 238-6 for housing which project out relative to the general space occupied by the module. This depth of projection corresponds roughly to the thickness of wall 220 or 222 of the cage.

Faces 238-3 and 238-5 of frames 238-2 and 238-1 are provided with a toothed folding joint that assures a better connection along the joining line after folding, which may be very necessary in this variant with support spring.

This module is completed by a support spring referenced 250, of a Z shape. This spring has an intermediate zone of curvature and a distal support zone. More precisely, this spring arises from upper face 242-1, after cutting and its first arm 250-1 is situated in its extension. The second arm 250-2 is inclined upstream and has a height roughly equal to height h of the module, in order to form a double curvature The third distal arm 250-3 is parallel to the first and is extended downstream so as to pass just above or below the first arm. The double Z curve is such that the support spring has a total height slightly greater than the inner height of the cage in which it is housed. This permits slightly compressing this support spring 250. The arms of this spring can also be divided like the blades so as to have two springs able to act independently. In addition, the shape of this spring is optimized but it can have a different profile without exceeding the scope of the invention, as long as it contacts the inside of the cage to obtain the desired characteristics, such as in the last embodiment described below.

In a manner homothetic to the placement of faces 238-3 to 238-6 for housing the module, two downstream openings 252-1, 252-2 and two upstream openings 252-3 and 252-4 are arranged in body 212 of the cage on the corresponding faces, here left and right lateral faces 220 and 222, which openings are provided to receive the projecting faces of the module.

The upstream and downstream openings each have a length longer than the size of each of faces 238-3 and 238-4 that they receive to generate a play i on either side of each face in each opening; see FIG. 10B. This play is necessary for the movements of the blades and the module during the introduction of the plug to be received.

In fact, during the introduction of the plug, the curvature of the blades is decreased, which necessarily induces a lengthening of the module.

It is also noted that this arrangement permits holding the module in translation once it is inserted into the cage, since even in the case of relaxation of the stresses, notably upon removal of a plug previously inserted, for example, the module is held in place in the cage.

With regard to support spring 250, it is preferably soldered onto the cage as shown in FIG. 9B, for example, by a point solder 251 by means of a laser gun, for example, or by any other analogous means. This soldering is carried out on the end of distal arm 250-3. This immobilizes the whole module while permitting the movements generated by contact of the plug into the contact.

One can also anticipate a blank for creating the cage that permits positioning a joining line 228 on lower face 242-2. In this case, solder point 251 of distal arm 250-3 can also be common with the solder that assures coupling of the edges of the blank along joining line 228.

Moreover, such a soldered connection permits assuring better electrical conduction.

It is observed that the spring is held at stops upstream and downstream by the cooperation of the faces of the module with the openings of the cage and that the spring supports the module and limits the translation movements of low amplitude generated by vibrations in the ±area.

As a variant, it can be anticipated that only one of the openings on one of the faces may have a length longer than the dimension of the face that it receives to generate play.

One of the advantages of such an arrangement is the freeing-up of useful space throughout almost all of the cage. Since the projecting faces have a thickness roughly identical to that of the walls of the cage, these faces are housed in the thickness of the wall of the cage and free the inner space of the cage allowing the use and the passage of plugs of greater dimensions, for the smallest width.

In FIGS. 10A and 10B, identical references have been increased by 100 for elements common to the preceding embodiment with the Z-shaped spring of FIGS. 9A and 9B. An optimized embodiment is shown in which support spring 350 is modified and has the shape of a C with a distal arm 350-3. Moreover, it is observed that this spring arises from lower face 342-2 of rear part 338-2. The support spring is soldered to upper face 316 of the cage by its distal arm 350-3, at a point 351. This soldering can be done directly through face 316. There is therefore no longer an intermediate curvature zone and a distal support zone.

It is therefore possible to position a common solder point 351 to connect the edges of the blank making up the cage and distal arm 350-3.

The “fretting corrosion” phenomenon at the point of contact with the pin is eliminated.

The preferred embodiment that has been described above can be reduced in the sense that faces 338-3 to 338-6 can be limited to a single upstream pair of faces 338-5, 338-6 or to a single lateral pair 338-3, 3[3]8-5 or 338-4, 338-6.

In the embodiments that have just been described, it is also noted that the opening of the cage permitting introduction of the plug need not necessarily have flaps. This cutting out and folding operation is eliminated. Advantageously, during cutting of the blank, a small chamfer can be provided in the thickness so as to facilitate the introduction of the plug to be received once the cage is formed and the module is positioned.

In order to prevent any risk of erroneous introduction, it is possible to adjoin in a known manner the polarization means for the cage contact thus described. Such means are present in the form of an asymmetry of the cage which is provided, for example, with a boss while the reception socket, not shown, has a conjugate profile.

The cost of such a contact is reduced and the manufacturing steps are industrially simplified since there is only one additionally bending step. There is therefore no additional free part. The support spring can be attached simultaneously when providing the soldering points of the cage.

The number of blades such as described is four blades but it can be reduced to only two blades, one upper and the other lower.

A cage created according to these embodiments is very stiff and the symmetric module assures a great stability once it is mounted and also facilitates industrial manufacture.

1. A female contact having a cage structure of parallelepiped shape, with an upper face (16), a lower face (18) and two lateral faces (20, 22), designed to receive a plug, characterized in that it comprises a blade-holder module (36) whose arms (42-1 and 42-2) are arranged parallelly to upper face (16) and lower face (18) of the cage, body (38) of blade-holder module (36) comprising an upstream part (38-1) separated from a downstream part (38-2) and at least two curved blades (40) positioned face-to-face between these two parts, roughly in the continuity of the planes of upper face (42-1) and lower face (42-2) of this body.

2. The female contact having a cage structure of parallelepiped shape according to claim 1, further characterized in that face-to-face blades (40) have opposite curvatures and are oriented to bring the top parts of the curves together.

3. The female contact having a cage structure of parallelepiped shape according to claim 1 or 2, further characterized in that blades (40) each comprise a median longitudinal opening (44-1, 44-2) so as to divide them (40-1 to 40-4).

4. The female contact having a cage structure of parallelepiped shape according to claim 3, further characterized in that blades (40) divided from a single face have offset contact points, one upstream and the other downstream.

5. The female contact having a cage structure of parallelepiped shape according to any one of the preceding claims, further characterized in that body (38) of the module is held by at least two flaps (16-1, 16-2) formed by bending with cage (12) and positioned at the entrance to this cage, relataive to the direction of introduction (24).

6. The female contact having a cage structure of parallelepiped shape according to any one of the [preceding] claims, further characterized in that it comprises at least one depression (46) and at least one slot (48), one borne by cage (12) and the other by body (38) of the module.

7. The female contact having a cage structure of parallelepiped shape according to claim 6, further characterized in that at least one slot (48) has a longitudinal dimension greater than that of at least one corresponding depression so as to generate a play J.

8. The female contact having a cage structure of parallelepiped shape according to any one of the preceding claims, further characterized in that blade-holder module (136) comprises two frames, upstream frame (138-1) and downstream frame (138-2) with closed cross section, faces (142-1, 142-2) of these frames bearing blades (140) being positioned parallelly to upper face (116) and lower face (118) of the cage.

9. The female contact having a cage structure of parallelepiped shape according to claim 8, further characterized in that the cage comprises at least two openings (152-1 to 152-4) and the frames comprise at least two projecting faces (138-3 to 138-6), provided to cooperate by fitting together with said openings.

10. The female contact having a cage structure of parallelepiped shape according to claim 9, further characterized in that the projection thickness of faces (138-3 to 138-6) corresponds roughly to the thickness of the walls of the cage comprising corresponding openings (152-1 to 152-4).

11. The female contact having a cage structure of parallelepiped shape according to any one of claims 8 to 10, further characterized in that in the case of a cage with four openings (152-1 to 152-4), the frames comprise four projecting faces (138-3 to 138-6), the two downstream openings (152-1,152-2) having a length greater than the dimension of faces (138-3,138-4) that they receive to generate an operational play J.

12. The female contact having a cage structure of parallelepiped shape according to any one of claims 1 to 8, further characterized in that upper face (42-1) and lower face (42-2) of body (38) of the module each bear at least one stud (50-1 to 50-4), projecting into the plane of these faces and provided to cooperate with at least one opening (52-1, 52-2) created in cage (12).

13. The female contact having a cage structure of parallelepiped shape according to claim 12, further characterized in that in the case of four studs, two studs called upstream studs, are borne by the upstream part and two studs called downstream studs, are borne by the downstream part, and opening (52-2) receiving the downstream studs has a longitudinal dimension greater than that of the corresponding studs so as to generate a play J.

14. The female contact having a cage structure of parallelepiped shape according to any one of the preceding claims, further characterized in that blade-holder module (236, 336) comprises at least one support spring (250, 350), positioned downstream and arising from said module, coming to be housed in the cage.

15. The female contact having a cage structure of parallelepiped shape according to claim 14, further characterized in that support spring (250, 350) has an intermediate curvature zone and a distal support zone (250-3, 350-3) in the cage.

16. The female contact having a cage structure according to claim 14 or 15, further characterized in that curvature zone (250-1, 250-2, 250-3) of spring (250) comprises two opposed curves in a Z shape.

17. The female contact having a cage structure of parallelepiped shape according to claim 16, further characterized in that the Z shape comprises three arms (250-1, 250-2 and 250-3), the first (250-1) being cut out with module (236), the second (250-2), inclined upstream, assuring the spring effect, and the distal third (250-3) being parallel to the first and provided to be supported in the cage.

18. The female contact having a cage structure of parallelepipeded shape according to any one of claims 14 to 17, further characterized in that spring (250, 350) is connected to the cage by a solder (251, 351) at the level of its distal arm (250-3, 350-3).

19. The female contact having a cage structure of parallelepiped shape according to any one of claims 14 to 18, further characterized in that the cage, made up of a folded blank, has on the upper face a joining line (228, 328) with a solder point (251, 351) common to that which connects spring (250, 350) to the cage at the level of distal arm (250-3, 350-3).

20. The female contact having a cage structure of parallelepiped shape according to any one of the preceding claims, further characterized in that module (36) has a rigid body and elastic arms.
